(19) United States
(12) Patent Application Publication
(10) Pub. No.: US 2003/0155736 A1
(43) Pub. Date: Aug. 21, 2003

(54) Tension fitting, distortion fender

(76) Inventor: Calvin Dean Ludvigsen, Glendora, CA (US)

Correspondence Address: Calvin Dean Ludvigsen, 855 Bradish Avenue, Glendora, CA, 91740, US

(21) Appl. No.: 10/357,955

(22) Filed: Feb. 4, 2003

Related U.S. Application Data
(60) Provisional application No. 60/357,988, filed on Feb. 20, 2002.

(51) Int. Cl. B62D 25/18

(52) U.S. Cl. 280/152.3

(57) ABSTRACT

A novel, single piece, self-attaching, self-supporting rear splash-guard (fender), for bicycles comprised of a flat sheet (in finished form) of resilient material of distinct design. Utilizing the ability to manually distort, and maintain a degree of distortion to the said splash-guard, through confinement by the present bicycle saddle or saddle support system of so designed fender as means to achieve attachment of fender to the bicycle, the three-dimensional quality and contours of the fender, and sufficient degree of rigidity for operation.

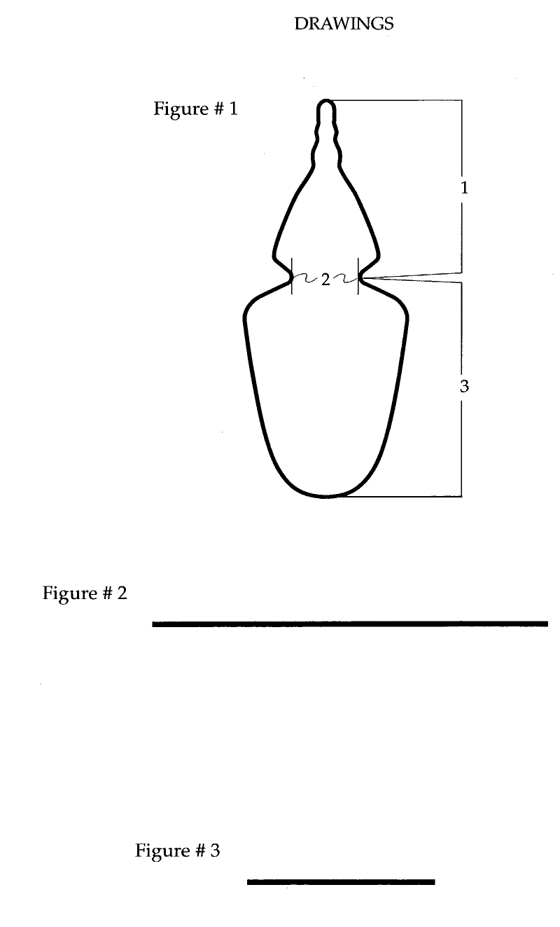

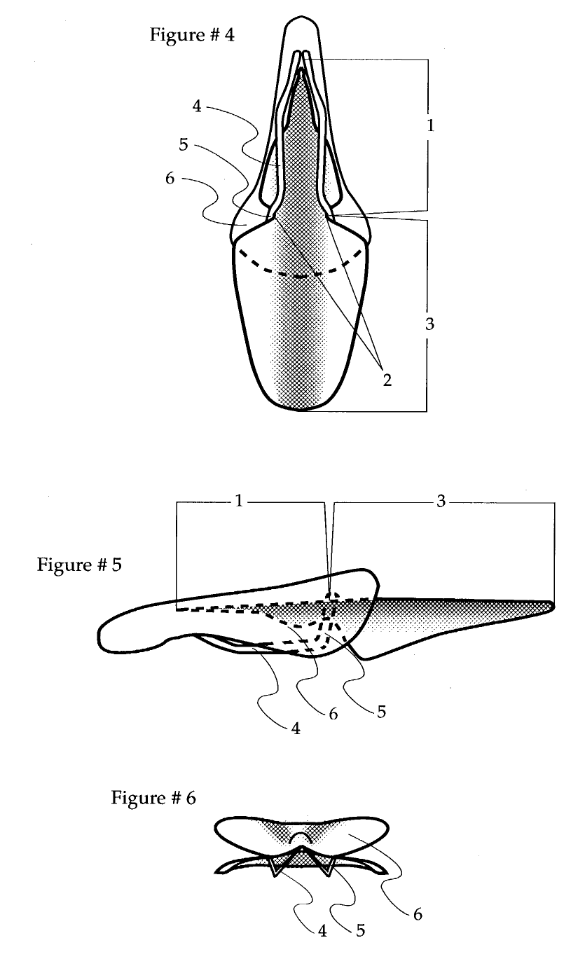

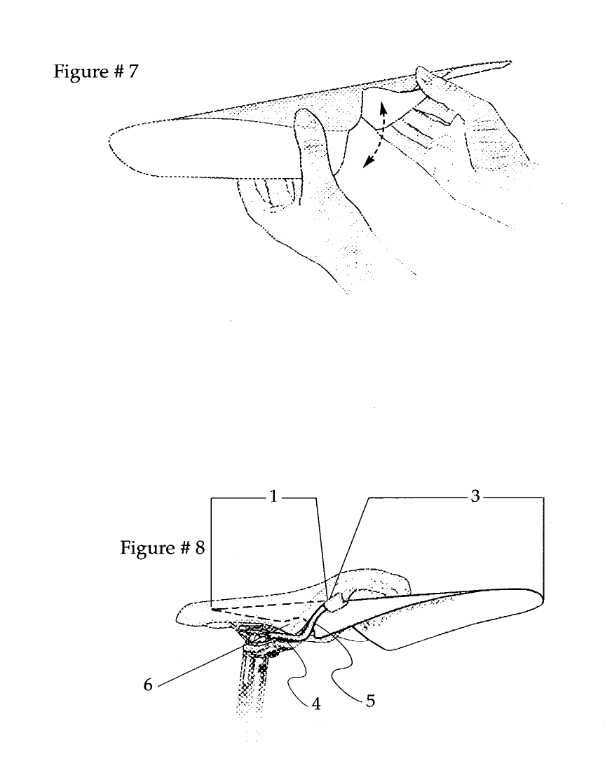

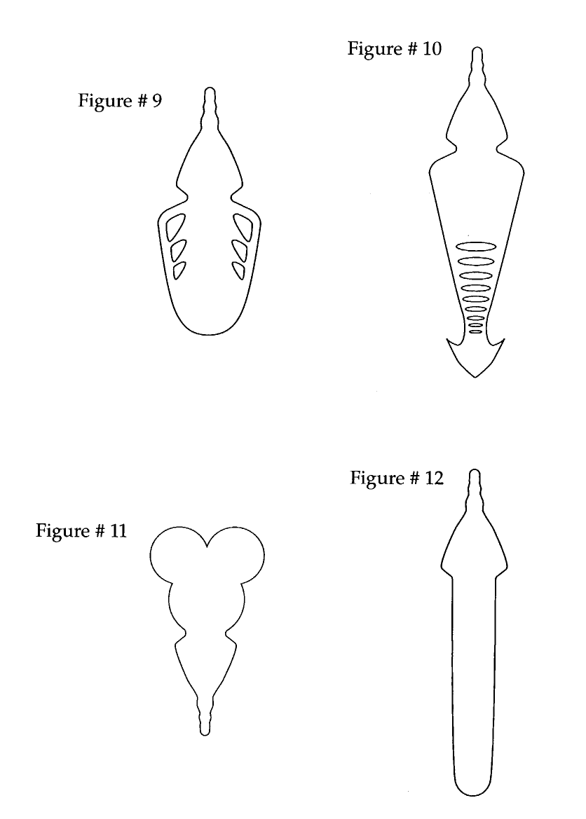

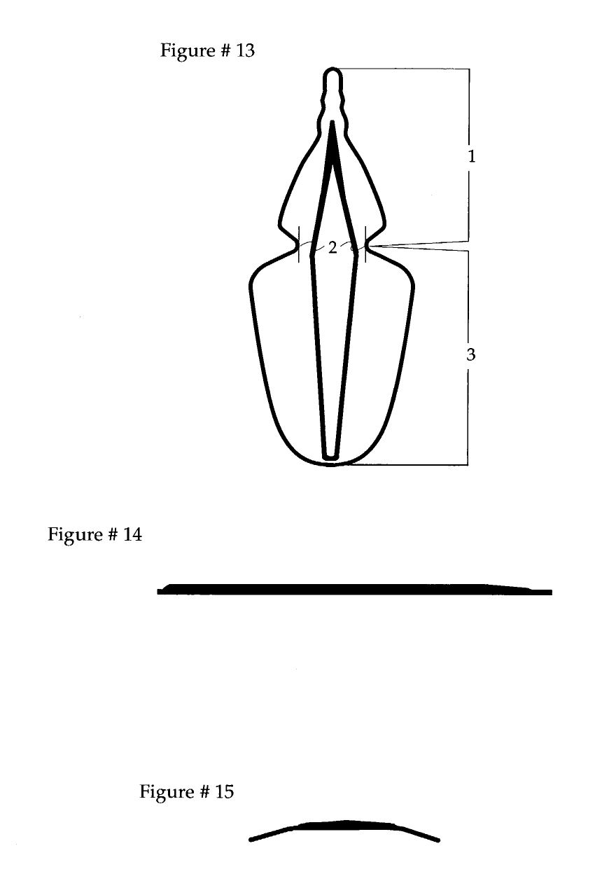

### REFERENCE TO PROVISIONAL PATENT

This application is a continuation of my provisional patent application serial No.: 60/357,988, filled Feb. 20, 2002, entitled, “Tension Mounted Bicycle Fender”.

### STATEMENT REGARDING FEDERALLY SPONSORED RESEARCH

### OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention pertains to the field of bicycles and bicycling. Generally it relates to bicycle fenders and mudguards, and more specifically to lightweight rear spay shield, tail covers for ornamental, aesthetic, and functional consideration, providing a degree of protection to the rider and saddle from material propelled by the spinning action of bicycle tires in motion.

### DESCRIPTION OF PRIOR ART

Modern cyclist can be grouped into three general categories: road, mountain, and casual. Each group is concerned to a varying degree with issues of weight, appearance, maintenance and comfort. Lightness, pleasing aesthetic value, low maintenance and maximum comfort being desirable aspects of high quality bicycles and the bicycling experience. Choice of components and accessories (such as fenders) are often made on the basis of their weight (measured in grams). This is the primary reason fenders are not normally used on most road and mountain bicycles. Aesthetic value is also a factor in the decision to employ a fender. Most fenders are large and bulky because they attempt to cover a majority of the bicycle tire. As a result, fenders detract from the sleek and fast aerodynamic nature of modern bicycle design. Virtually all commercially available bicycle fenders are attached by some form of hardware and therefore maintenance and comfort become a consideration for all three groups. Road and trail vibration will tend to loosen fender attachment hardware, causing unwelcome maintenance and adjustments. This creates an opportunity for part failure and a most discomforting vibration noise that can be extremely distracting to the bicycling experience.

U.S. Pat. No. 5,762,349; Gancarz, Robert M., (Jun. 9, 1998), teaches a rear fender for bicycles comprised of “a sheet of semi-rigid body” folded cone-like to be slid over and around the entire bicycle saddle in a rearward direction, to cantilever over the rear wheel.

The attachment method of this fender is inadequate and dangerous. The attachment hardware (“Velcro”) looses effectiveness with wear and exposure to dirt, it is not strong enough to hold the folded shape in off-road and prolonged riding conditions, and against the force of the riders movement; as by design the rider is in direct contact with the fender in its operative position. It is further attached by sliding over the bicycle saddle, requiring the rider to sit on top of the fender itself. This can cause the rider to slip on the fender surface or the fender may slip around the saddle, resulting in loss of control and injury. By way of design this fender nullifies the comfort, style, safety and tactile engineering that has gone into the bicycle saddle, an important and expensive component.

U.S. Pat. No. 5,868,411; Dymeck, Jeffrey, (Feb. 9, 1999), teaches a rear fender for bicycles that emanates from the underside of the bicycle seat, being cantilevered over the rear wheel. This fender is comprised of a single piece rigid or semi-rigid plastic element, attached by means of a forward tongue portion which wedges itself between the underside of the seat and the converging metal rails and a middle portion with notches that attach precisely between the substantially vertical seat rails. “Placement of notches varies in accordance with the specifications of various seat manufacturers”.

The obvious problem with this design is the stated need for a different fender (notch size and placement and “forward tongue” size) for every seat manufacturer and saddle size. This would cause great confusion to the consumer, and the expense of manufacture as well as maintaining multiple inventories would most likely preclude it from market. The attachment of this fender further relies on the hope that the said notches will remain parallel to one another (the prescribed removal action is a twist at the notch portion). It appears this removal action can be initiated by a fall, inadvertent rider contact during mount or dismount of bicycle, or bicycle operation on particularly rugged terrain, thus, requiring constant adjustment.

U.S. Pat. No. 5,918,904; Hanesworth, Don, (Jul. 6, 1999), teaches a rear fender with an extremely heavy and complex attachment apparatus consisting of a post receiving member and a seat receiving member affixed to one another by at least one vertical support. An extension of the seat receiving member—(a rail receiving surface member)—with two sides (a front and a back) that defines an opening in which is placed a spring for the purpose of providing force against the saddle rail, is further comprised of seat receiving risers. The post receiving member is comprised of a pair of prongs that rest on the seat post. This contraption is further connected to the cantilever portion of the fender by a series of vertical and horizontal slide brackets and set screws.

This device serves to amplify all traditional problems associated with weight, maintenance, and comfort.

### BRIEF SUMMERY OF THE INVENTION

The object of the present invention is a novel interpretation of a bicycle splash guard providing functional and ornamental aspects, and advantages previously non existent by this type of product in the bicycling field, In addition, solving existing problems with prior art, primarily by way of its unique design and attachment method, and the decision to focus only on what is believed to be the most serious area of tangential spray.

A reliable lightweight, single piece, two-dimensional, universally fitting, rear splash-guard for bicycles, comprised of any resilient material (including but not be limited to papers and cardboard coated or non-coated, plastics, vinyls, acrylics, laminates, phenolic, nylon, acetate or foam). The said resilient material to be manually distorted (compressed) in a concave manor along the length and inserted under the bicycle saddle in a forward direction, between and perpendicular to the vertical portion of the bicycle saddle support rails. Released, it will expand to its natural un-distorted form. As the width of the fender where it comes in contact with the bicycle saddle rails is wider than the distance between the bicycle saddle rails, it will be confined by the rails and a degree of distortion will be maintained, providing a three-dimensional appearance. Expansion of the fender will continue from the rail-contact point backward and forward, with the forward portion being prevented from completing this action by contact with the underside of the bicycle saddle. This force causes tension and friction used to adhere the fender steadfast to the bicycle saddle. This method for attachment is not disclosed in prior art.

The degree of maintained distortion supplies sufficient rigidity to cantilever the backward portion over the rear wheel and supply a three-dimensional quality to the flat sheet. Using this distortion to achieve the desired contours is not disclosed in prior art and negates the need for expensive molds required to achieve contour as in prior art. Prior art claims to be lightweight but attachment hardware or material requirements to overcome the physics of secure attachment mitigate their claims of “lightness”. Working and tested fenders of the present invention design have weight between ten and twenty eight grams.

The present invention—a flat sheet—in its finished form, not requiring additional forming, allows unprecedented opportunity for decoration. Decoration may include printing of material with any manual or automated process including offset, flexographic, screen, gravure, embossing, molding or foil stamping of material, lamination of any embellishment including reflectors and blinkers. Decoration may also include the cut shape of the said fender into any natural or man-made object or shape including plant, animal, mineral, geophysical, tool, machine, architecture, landmark, trademark or logo.

The present invention's simplicity of design allows for manufacture from a multitude of materials, affording unprecedented usage opportunities, including previously not disclosed disposable or promotional fenders.

The simplicity of design with the unique attachment method of the present invention is maintenance free.

The present invention, by way of its form emulates a proven desired aesthetic element: the integrated saddle/fender of modern road and off-road motorcycles known as a “tail cover”. Prior art state no active motion toward aesthetic purpose.

Relative “lightness”may be achieved with the three-piece (one plus two velcro tabs) design of: U.S. Pat. No. 5,762,349; Gancarz, Robert M. (Jun. 9, 1998). However, being wrapped around the bicycle saddle while in operation poses risk of injury to the rider and the need for continual adjustment. Its “Velcro” fastener is inadequate as well.

These problems are overcome by the present inventions described attachment method and one-piece design.

The one-piece design of: U.S. Pat. No. 5,868,411; Dymeck, Jeffrey, (Feb. 9, 1999), requires no hardware but has the significant disadvantage of requiring precisely placed notches of substantial thickness and a precisely sized forward tongue section for each different size or manufactures' bicycle saddle specifications, (a different fender for every saddle type, size, and brand). A further disadvantage is the possibility of unintentional disengagement. As the removal process is described as a twisting action, typically encountered by rear fenders in a fall, by rider contact during mount and dismount, or trail vibration.

The present invention is able to overcome these disadvantages by a secure and novel attachment method that does not require the placement of notches (precise or otherwise) or a defined or precise forward section that wedge between variously converging rails and the underside of the a bicycle saddle. As the present invention shape and contours are not molded, but achieved through maintained distortion, it will tend to give to force before it becomes disengaged, bolstering the claim to maintenance-free reliable operation.

### BRIEF DESCRIPTION OF THE SEVERAL VIEWS OF THE DRAWING

FIG. #1. Top view draft of present invention in natural “relaxed” state.

FIG. #2. Side view draft of present invention in natural “relaxed” state.

FIG. #3. Front view draft of present invention in natural “relaxed” state.

FIG. #4. Top view draft of present invention in operational “distorted” state, (installed).

FIG. #5. Side view draft of present invention in operational “distorted” state, (installed).

FIG. #6. Front view draft of present invention in operational “distorted” state, (installed).

FIG. #7. Side view illustration of compression (distortion) action required for present invention utility.

FIG. #8. Forty-five degree back view illustration of present invention installed (attached to saddle).

FIG. #9. Top view draft of present invention modified form of construction: “vented”.

FIG. #10. Top view draft of present invention modified form of construction: “tail”.

FIG. #11. Top view draft of present invention modified form of construction: “trademark/logo”.

FIG. #12. Top view draft of present invention modified form of construction: “straight” (no rear flare).

FIG. #13. Top view draft of present invention modified form of construction: “molded channel and arc”.

FIG. #14. Side view draft of present invention modified form of construction: “molded channel and arc”.

FIG. #15. Front view draft of present invention modified form of construction: “molded channel and arc”.

### REFERENCE NUMERALS IN DRAWINGS

1. Forward tang section of fender.

2. Width of fender at bicycle saddle support rail contact point.

3. Cantilever section of fender.

4. Horizontal portion of bicycle saddle support rails.

5. Vertical portion of bicycle saddle support rails.

6. Underside of bicycle saddle.

### DETAILED DESCRIPTION OF THE INVENTION

The present invention is a rear bicycle fender of simple design. It consist of a single sheet of resilient material configured in two sections: the tang section and the cantilever section. The width where these two sections meet is greater then the distance between the parallel vertical portion of a standard bicycle saddle support rail system. The tang section attaches the fender to the bicycle saddle by inserting it in a forward direction between the back saddle support rails under the saddle while the fender is manually distorted in a concave manor along its length. When released, both the tang and the cantilever sections will move to return to their un-distorted state. This action will be confined for the tang section as it comes in contact with the underside of the saddle.

The resilient nature of the material will apply continual pressure on the underside of the saddle providing tension and friction sufficient to secure the fender to the saddle, projecting the cantilever section over the rear wheel of the bicycle. As the tang section is inserted fully to the point that the cantilever section begins, where these two sections meet, is the contact point to the parallel vertical portion of the saddle rails when the fender is installed. As the fender width at that point is greater then the distance between the parallel vertical portion of the bicycle saddle support rails, a degree of distortion is maintained providing improved rigidity, a three-dimensional quality and contour to the fender.

The above mentioned previously not disclosed method of attachment and form has an advantage over prior art as it does not require any attachment hardware or fastener, nor does it rely on precisely placed or sized notches or other components. Thus providing a simple to make, one size fits all product. The above mentioned previously not disclosed method of attachment and form has advantage over prior art as it is a more secure maintenance free method of attachment then prior art has shown. The above mentioned previously not disclosed method of attachment and form has an advantage over prior art as it relies only on maintained manual distortion of a material sheet for contour and three dimensional attributes, therefor providing for a simple manufacture process from a larger variety of materials and affording a larger variety of uses and decor possibilities.

The present invention can be manufactured by manually cutting with scissors or snips a sheet of resilient material in the size and shape roughly that of FIG. #1. Starting at the top of a 6.5″×15.5″ sheet of resilient material at 6″ down from each side cut in toward the center at a 45 degree downward angle to 1.875″ from the edge then back out and down to the edge removing a triangular piece from each side. The resulting shape is a head and body with a 2.75″ neck. The head (attachment part) should be further cut to a preferred arrowhead shape to fit under the bicycle saddle. The body (cantilever part) can be any desired shape, the preferred shape being a round-corner tapered rectangle. The present invention described herein was manufactured with one or more of the following methods and materials: 1. Cardboard, polypropylene, polycarbonate, polyethylene, neoprene, nylon, manually cut using sewing scissors. 2. Cardboard, polypropylene, polycarbonate, polyethylene neoprene, nylon, machine stamped using a steel die. 3. Cardboard, polyethylene, nylon thermal formed with a mold to create ribbing, trim and decorative design.

Referring to FIG. #1., top view draft of fender in relaxed state, the tang (1) is the section that provides attachment to the bicycle saddle. Inserted between the rails and under the saddle (when distorted in a concave manor along its length), then released, it is stopped from fully expanding to its original form by coming in contact with the underside of the saddle. The resulting tension and friction hold the fender in place. Although the tang can be any shape or size that fits under the saddle, it is most effective with maximum surface contact. Therefore the preferred embodiment would be a size and shape of the bicycle saddle underside. FIG. #1. (1) illustrates a saddle-shaped tang 7″ long by 4″ wide at largest dimensions. This size can accommodate larger saddles and requires minimal trimming for smaller saddles. FIG. #1. (2) is merely a width dimension where fender will contact vertical portion of saddle rails when installed. (2) Must be wider than the distance between the saddle rails (to maintain a degree of distortion), yet not so wide that distortion causes a crease or damage to the fender or loss of stability. FIG. #1. (2) illustrates a width of 2.75″, to accommodate standard rail width, providing an optimal degree of distortion when installed. FIG. #1. (3) is the section of the fender to cantilever over the rear wheel thus providing spray deflection. This section can be any shape or size that allows utility and operation. Width up to 8″ and length up to 20″ have been tested and found operational. FIG. #1. (3) illustrates a rounded corner triangular shaped section 6.25″ wide by 8.5″ long.

FIG. #2. (side view draft of fender relaxed state) and FIG. #3. (front view draft of fender relaxed state) illustrate a featureless two-dimensional flat sheet fender.

6 FIG. #4. illustrates the present invention after it has been distorted and inserted in a forward direction between the back saddle support rails under the saddle, then released. It is still in a un-relaxed state of distortion, being confined at points (2) by the vertical portion of the bicycle support rail system. The cantilever section (3) extends beyond the back of the saddle over the rear bicycle wheel, as it reaches its relaxed state at the outermost tip. The tang section expands to its relaxed state until confined by the underside of the bicycle saddle (6), creating tension sufficient to secure the fender to the bicycle saddle. The attachment process and configuration as well as the three-dimensional qualities and contours of the present invention are further demonstrated in FIG. #5 (side view, installed), FIG. #6 (front view, installed), and FIG. #8 (forty-five degree back view, installed). FIG. #5 illustrates the distortion in a concave manor along the length of the fender, required for installation.

The cantilever section of the present invention can be formed in any custom shape. FIGS. #9 through #12 illustrate a variance of cut shapes.

While not necessary, thermo-forming can be used to introduce a pre-distortion contour, or arc and ribbing trim or decoration. Illustrated in FIGS. #13 through #15.

What is claimed to be new and desired to be protected by letters of patent of the United States is as follows:

1. A rear splash-guard for bicycles, two-dimensional in finished form, for permanent or non-permanent use, comprised of a sheet of any resilient material, and relying on the ability to manually distort, and maintain a degree of distortion to the said resilient material, through confinement by the present bicycle saddle or saddle support system, and the inherent effects of said distortion as means by which the three-dimensional quality, (including contour and rigidity), of said splash-guard is achieved or enhanced.

2. A rear splash-guard for bicycles, for permanent or non-permanent use, comprised of a sheet of any resilient material, that relies on the ability to manually distort, and maintain a degree of distortion to the said resilient material, through confinement by the present bicycle saddle or saddle support system, and the inherent effects of said distortion as means by which the splash-guard is attached, or attachment is assisted, to the bicycle.

3. A rear bicycle fender as claimed in claims 1 through 2 that appearance or utility is enhanced by laminating, printing, molding or forming in any way, ribbing, channels, trim, decor, or any degree of arc or dimension or manual trimming to custom size or shape.

4. A rear bicycle fender as claimed in claims 1 through 3 whose purpose includes ornamentation or attachment of ornamentation.
